(19) United States
(12) Patent Application Publication
(10) Pub. No.: US 2014/0262073 A1
(43) Pub. Date: Sep. 18, 2014

(54) Product Using Multiple Slats

(71) Applicant: Steve Timmons, Pleasantville, IA (US)

(72) Inventor: Steve Timmons, Pleasantville, IA (US)

(21) Appl. No.: 13/832,663

(22) Filed: Mar. 15, 2013

(51) Int. Cl. E06B 9/386

(52) U.S. Cl. CPC E06B 9/386
USPC 160/218; 29/428

(57) ABSTRACT

Example embodiments are directed to a product comprised of a plurality of slats. In example embodiments, the slats may be marked to form an image or a pattern and the product may be used as a window covering.

### BACKGROUND

1. Field

Example embodiments are directed to products comprised of a plurality of slats. In example embodiments, the slats may be marked, for example, by etching or engraving, to form an image thereon. In example embodiments, the slats may be made from a transparent material and the image may resemble a three dimensional image. In example embodiments the products may be used for multiple purposes, for example, the product may be used as a window covering.

2. Description of the Related Art

Slats used for window coverings are common in the art. Most slats, however, have a generally flat appearance which some consider unappealing. In order to render slats more appealing, certain market participants have provided decals or coverings to make the slats more appealing. These modifications, however, still render the window slats flat and unappealing.

### SUMMARY

The inventor has discovered an improved window covering having aesthetic characteristics superior to those of the conventional art. In particular, the inventor has improved upon conventional window coverings by producing a window covering from a plurality of slats engraved to form a 3D image. Such a window covering has an aesthetically far more pleasing effect than the conventional art. Although the primary intent was to create an improved window covering, the inventor has found that his invention has a variety of other applications such as, but not limited to, messaging boards and art work.

Example embodiments are directed to a product comprised of a plurality of slats. In example embodiments, individual slats may be marked, for example, by etching, engraving etc., then arranged to form an image or a pattern thereon.

In accordance with example embodiments, a product may include a plurality of slats prearranged in structure, wherein the plurality of slats form a surface having an image etched, engraved etc. thereon.

### BRIEF DESCRIPTION OF THE DRAWINGS

Example embodiments are described in detail below with reference to the attached figures, wherein:

FIG. 1 is a view of a product in accordance with example embodiments;

FIGS. 2A-2C illustrate a method usable for producing a slat accordance with example embodiments;

FIG. 3 is a section view of a slat in accordance with example embodiments;

FIGS. 4A-4D are views showing slats nesting together in accordance with example embodiments;

FIGS. 5A-5C are views of a plurality of slats with an image formed thereon in accordance with example embodiments;

FIG. 6 is a view of a plurality of slats in accordance with example embodiments;

FIG. 7 is a view of a frame in accordance with example embodiments;

FIGS. 8A and 8B are views of a plurality of slats inserted into a fame in accordance with example embodiments;

FIGS. 9A and 9B illustrate a slat and a rod in accordance with example embodiments;

FIGS. 10A and 10B illustrate a plurality of slats in a frame in accordance with example embodiments;

FIGS. 11A-11D illustrate a method usable for producing a slat accordance with example embodiments;

FIG. 12 is a cross section view of a slat in accordance with example embodiments;

FIGS. 13A and 13B illustrate a plurality of slats in an unnested and nested configuration in accordance with example embodiments;

FIGS. 14A and 14B illustrate a plurality of slats in accordance with example embodiments;

FIGS. 15A and 15B illustrate a plurality of slats assembled as a horizontal blind in accordance with example embodiments;

FIG. 16 illustrates a triangular slat in accordance with example embodiments;

FIGS. 17-19 illustrate views of a plurality of triangular slats in accordance with example embodiments;

FIG. 20 illustrates a plurality of triangular slats and a jig in accordance with example embodiments, wherein an image is formed on a first major surface of the plurality of triangular slats;

FIG. 21 illustrates a plurality of triangular slats with an image formed on a second major surface of the plurality of triangular slats in accordance with example embodiments;

FIG. 22 illustrates a plurality of triangular slats with an image formed on a third major surface of the plurality of triangular slats in accordance with example embodiments;

FIG. 23 illustrates a plurality of triangular slats with a plurality of posts formed thereon in accordance with example embodiments;

FIG. 24 illustrates an example of a frame in accordance with example embodiments;

FIGS. 25A-25C illustrate a plurality of triangular slats supported by a frame in accordance with example embodiments;

FIG. 26 illustrates an example of a plurality of slats supported by a frame in accordance with example embodiments; and

FIGS. 27A and 27B are views of a product comprised of a plurality of slats in accordance with example embodiments.

### DETAILED DESCRIPTION

Example embodiments of the invention will now be described with reference to the accompanying drawings. Example embodiments, however, should not be construed as limiting the invention since the invention may be embodied in different forms. Example embodiments illustrated in the figures are provided so that this disclosure will be thorough and complete. In the drawings, the sizes of components may be exaggerated for clarity.

In this application, when an element is referred to as being “on,” “attached to,” “connected to,” or “coupled to” another element, it can be directly on, attached to, connected to, or coupled to the other element or intervening elements that may be present. On the other hand, when an element is referred to as being “directly on,” “directly attached to,” “directly connected to,” or “directly coupled to” another element, there are no intervening elements present. As used herein, the term “and/or” includes any and all combinations of one or more of the associated listed items.

In this application, the terms first, second, etc. are used to describe various elements, components, regions, layers, and/or sections. However, these elements, components, regions, layers, and/or sections should not be limited by these terms since these terms are only used to distinguish one element, component, region, layer, and/or section from other elements, components, regions, layers, and/or sections that may be present. For example, a first element, component, region, layer or section discussed below could be termed a second element, component, region, layer, or section.

In this application, spatial terms, such as “beneath,” “below,” “lower,” “over,” “above,” and “upper” (and the like) are used for ease of description to describe one element or feature's relationship to another element(s) or feature(s). The invention, however, is not intended to be limited by these spatial terms. For example, if an example of the invention illustrated in the figures is turned over, elements described as “over” or “above” other elements or features would then be oriented “under” or “below” the other elements or features. Thus, the spatial term “over” may encompass both an orientation of above and below. The device may be otherwise oriented (for example, rotated 45 degrees, 90 degrees, 180 degrees, or at other orientations) and the spatially relative descriptors used herein interpreted accordingly.

In this application, example embodiments may be described by referring to plan views and/or cross-sectional views which may be ideal schematic views. However, it is understood the views may be modified depending on manufacturing technologies and/or tolerances. Accordingly, the invention is not limited by the examples illustrated in the views, but may include modifications in configurations formed on the basis of manufacturing process. Therefore, regions illustrated in the figures are schematic and exemplary and do not limit the invention.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments are directed to a product comprised of a plurality of slats.

FIG. 1 is a view of a product 1000 in accordance with example embodiments. In example embodiments the product 1000 may be comprised of a plurality of slats 100 which may have an image 200 formed thereon. In FIG. 1, twenty three slats 100 are illustrated, however, the product 1000 may include more than twenty three slats or less than twenty three slats. Also, although the image 200 illustrated in FIG. 1 is in the shape of a bear, example embodiments are not limited thereto as the image 200 may be any kind of image, for example, a text image, an image of a building, an image of scenery, and/or an image of a person.

In example embodiments, the slats 100 may be comprised of a transparent material, a semitransparent material, and/or an opaque material. For example, the slats 100 may be made from glass or plastic. The instant list, however, is exemplary only as the slats may be made from other types of materials including, but not limited to, metals, polymers, and/or composite materials. In example embodiments, a cross-section of the slats may have any shape including, but not limited to, a circular shape, a semicircular shape, a substantially rectangular shape, and/or a triangular shape.

In example embodiments, the slats 100 may be made via a number of different processes. For example, a slat 100 having a substantially half circle cross section may be formed by cutting a cylindrical piece of acrylic glass 100* in half (as shown in FIG. 2B) to form the two slats 100 (only one of which is shown in FIG. 2B). As another nonlimiting example, a mold in the shape of a half cylinder may be filled with methyl methacrylate in conjunction with a polymerization catalyst such as MEKP, to produce a hardened transparent Poly(methyl methacrylate), hereinafter (PMMA) in the form of the half cylinder slat 100 as shown in FIG. 2B. In either process, a transparent slat 100 having a half circle cross section is produced. Example embodiments, however, are not limited by the above methods as one skilled in the art would recognize a plethora of methods to produce a desired slat. For example, a mold having a rectangular or triangular shape maybe filled with the methyl methacrylate and the polymerization catalyst (or another material) to form a slat having a rectangular or triangular cross section. Although the instant examples illustrate the slat(s) 100 as being comprised of acrylic glass, the invention is not limited thereto since the slats may be made from other materials as is well known in the art.

In example embodiments, the slats 100 having the half circle cross section may be used directly in the product 1000 with little to no modification. For example, in example embodiments, the slats 100 may be lined up edge to edge to form a substantially flat surface and an image may be formed on a substantially flat surface via an image forming device such a laser or a router. However, example embodiments are not limited thereto. For example, in example embodiments, an edge of the slats 100 may be removed to form a notch 110. In example embodiments the notch 110 may run along a length of the slat 100. FIG. 2C, for example, shows a perspective view and a side view of a slat 100 having the notch 110 formed therein.

In example embodiments, the notch 110 may have a circular profile which may have the same radius of curvature R1 as the radius of curvature of the slat 100 as shown in FIG. 3. This aspect of example embodiments allows one slat 100 to nest against another slat 100 with very little to no gap. For example, FIG. 4A illustrates end views of a first slat 100-1 with a first notch 110-1, a second slat 100-2 with a second notch 110-2, a third slat 100-3 with a third notch 110-3, and a fourth slat 100-4 with a fourth notch 110-4. FIG. 4B illustrates the first slat 100-1 and the second slat 100-2 nested together. FIG. 4C illustrates the first, second, and third slats 100-1, 100-2, and 100-3 nested together. FIG. 4D illustrates all four slats 100-1, 100-2, 100-3, and 100-4 nested together to form a substantially flat continuous surface 120 and a substantially wavy surface 130 formed by the curved portions of the first, second, third, and fourth slats 100-1, 100-2, 100-3, and 100-4.

As mentioned above, the radius of curvature of the notch 110 may be about the same as the radius of curvature of the slat 100. However, example embodiments, are not limited thereto. For example, the radius of curvature of the notch 110 may be different from the radius of curvature of the slat 100 it is integral with. Further, the radius of curvature of the notch 110 may be the same as a radius of curvature of a neighboring slat 100 rather than the slat 100 it is integral with in the event the neighboring slat 100 has a different profile than the slat 100 in which the notch 110 is formed. On the other hand, example embodiments do not require adjacent slats 100 to be nested with each other. Thus, the notches 110 may be omitted entirely.

FIG. 5A is a perspective view of a plurality of nested slats 100 in accordance with example embodiments. In example embodiments, the plurality of nested slats 100 may be comprised of a first slat 100-1, a second slat 100-2, a third slat 100-3, a fourth slat 100-4, a fifth slat 100-5, a sixth slat 100-6, a seventh slat 100-7 and an eighth slat 100-8. Although eight slats are shown in this particular example, it is clear that the plurality of slats 100 may include more or less than eight slats 100.

In example embodiments, the plurality of slats 100 may be supported by a jig 140 so that the flat sides of the slats 100 are aligned to form the substantially flat and continuous surface 120. In example embodiments, an image forming device, for example, a router or a laser, may be used to form an image 150 on the plurality of nested slats 100 as shown in FIG. 5B. Although example embodiments illustrate the image 150 as being formed on the substantially flat and continuous surface 120, this is not intended to be a limiting feature of the invention since the image 150 may be formed on the substantially wavy surface 130 instead. For example, as shown in FIG. 5C, the plurality of slats 100 may be arranged on a jig 140* which has a substantially flat surface so that the plurality of slats 100 may be arranged thereon to form and expose the wavy surface 130. In this configuration, an image forming device, for example, a router or a laser, may be used to form an image 150 on the wavy surface 130.

In example embodiments, the plurality of slats 100 with the image 150 formed thereon may be suitable for various purposes. For example, the plurality of slats 100 may be supported by a window frame and used as a window covering. For example, as shown in FIG. 6, the plurality of slats 100 may be fitted with a first plurality of posts 160 and a second plurality of posts 170 which may be usable to connect the plurality of slats 100 to a window frame 200. For example, in example embodiments, the first plurality of posts 160 and the second plurality of posts 170 may be configured to insert into a first plurality of holes 260 and a second plurality of holes 270 that may reside in a window frame 200. For example, the first slat 100-1 may include a first post 160-1 and a second post 170-1 configured to slide into a first hole 260-1 and a second hole 270-1 of the window frame 200, the second slat 100-2 may include a third post 160-2 and a fourth post 170-2 configured to slide into a third hole 260-2 and a fourth hole 270-2 of the window frame 200, the third slat 100-3 may include a fifth post 160-3 and a sixth post 170-3 configured to slide into a fifth hole 260-3 and a sixth hole 270-3 of the window frame 200, the fourth slat 100-4 may include a seventh post 160-4 and an eighth post 170-4 configured to slide into a seventh hole 260-4 and an eighth hole 270-4 of the window frame 200, the fifth slat 100-5 may include a ninth post 160-5 and a tenth post 170-5 configured to slide into a ninth hole 260-5 and a tenth hole 270-5 of the window frame 200, the sixth slat 100-6 may include an eleventh post 160-6 and a twelfth post 170-6 configured to slide into an eleventh hole 260-6 and a twelfth hole 270-6 of the window frame 200, the seventh slat 100-7 may include a thirteenth post 160-7 and a fourteenth post 170-7 configured to slide into a thirteenth hole 260-7 and a fourteenth hole 270-7 of the window frame 200, and the eighth slat 100-8 may include a fifteenth post 160-8 and a sixteenth post 170-8 configured to slide into a fifteenth hole 260-8 and a sixteenth hole 270-8 of the window frame 200.

In example embodiments, each of the plurality of slats 100 may be free to pivot within their respective holes of the frame 200 and may be free to rotate independent of one another. In a first configuration, each of the slats 100 may be rotated so as to be in a nested configuration as shown in FIG. 8A. Thus, as shown in FIG. 8A, each of the plurality of slats 100-1, 100-2, 100-3, 100-4, 100-5, 100-6, 100-7, and 100-8 may be rotated to reveal the image 150 formed thereon. On the other hand, each of the slats 100-1, 100-2, 100-3, 100-4, 100-5, 100-6, 100-7, and 100-8 may be rotated ninety degrees from their nested configuration to hide the image 150 formed thereon as shown in FIG. 8B. On the other hand, only some of the slats 100-1, 100-2, 100-3, 100-4, 100-5, 100-6, 100-7, and 100-8 may be rotated such that only some of the slats 100-1, 100-2, 100-3, 100-4, 100-5, 100-6, 100-7, and 100-8 are nested. Thus, if desired, a user may display only a portion of the image 150 formed on the slats 100-1, 100-2, 100-3, 100-4, 100-5, 100-6, 100-7, and 100-8.

Example embodiments are not limited by the aforementioned example. For example, in example embodiments, the slats 100-1, 100-2, 100-3, 100-4, 100-5, 100-6, 100-7, and 100-8 may be further modified so that the slats 100-1, 100-2, 100-3, 100-4, 100-5, 100-6, 100-7, and 100-8 may be rotated together. For example, as shown in FIG. 9A a third plurality of posts 180 may be formed on the plurality of slats 100-1, 100-2, 100-3, 100-4, 100-5, 100-6, 100-7, and 100-8. In example embodiments, the third plurality of posts 180 may be configured to insert into a third plurality of holes 370 that may be formed in a rod 300 (see FIG. 9B). When a third plurality of posts 180 is inserted into the second plurality of holes 370, a translation of the rod 300 may simultaneously rotate each of the plurality of slats 100-1, 100-2, 100-3, 100-4, 100-5, 100-6, 100-7, and 100-8. For example, as shown in FIG. 10A, when the rod 300 is in a first position (as shown in FIG. 10A), the slats 100 may be arranged so that the image 150 on the plurality of slats 100-1, 100-2, 100-3, 100-4, 100-5, 100-6, 100-7, and 100-8 is observable. However, if the rod 300 is moved to a second position (as shown in FIG. 10B), the slats 100-1, 100-2, 100-3, 100-4, 100-5, 100-6, 100-7, and 100-8 may be rotated to obscure viewing the image 150.

Thus far, the slats 100 of example embodiments resemble a half cylinder. This, however, is not meant to be a limiting feature of the invention. For example, as illustrated in FIGS. 11A-11D, a slat 1100 having two flat sides may be prepared in a manner similar to preparing the slat 100. For example, in example embodiments, a cylindrical piece of an acrylic glass 1100*** (see FIG. 11A) may be cut in half (as shown in FIG. 11B) to form the intermediate slat 1100**. A second intermediate slat 1000* may be formed by cutting a notch 1110 in the intermediate slat 1000** as shown in FIG. 11C. In example embodiments, the notch 1110 may allow for nesting. Thus far, the second intermediate slat 1100* resembles the aforementioned slat 100. However, in example embodiments, an additional cutting operation may take place to remove a significant portion of the remaining curved portion of the intermediate slat 1100* to form a second flat surface as shown in FIG. 11D to substantially complete the slat 1100. The above method for producing a slat 1100 is not meant to limit the invention. For example, rather employing the above methods, a mold may be filled with methyl methacrylate in conjunction with a polymerization catalyst such as MEKP, to produce a hardened transparent Poly(methyl methacrylate) having the shape of the slat 1100.

In example embodiments, various aspects of the slat 1100 may be substantially similar to the slat 100. For example, as shown in FIG. 12, the notch 1110 may have a radius of curvature R3 which is substantially similar to a radius of curvature R3 of the remaining curved portion of the slat 1100. As in the earlier described slat 100, this aspect of example embodiments allows adjacent slats 1100 to nest with each other. For example, FIG. 13A represents a first slat 1100-1, a second slat 1100-2, a third slat 1100-3, and a fourth slat 1100-4 having the properties of the earlier described slat 1100. In example embodiments, the first, second, third, and fourth slats 1100-1, 1100-2, 1100-3, and 1100-4 may be nested together as shown FIG. 13B due to the presence of their respective notches. When nested together, the first, second, third, and fourth slats 1100-1, 1100-2, 1100-3, and 1100-4 may form a substantially flat and continuous surface 1130 and a substantially flat but discontinuous surface 1120.

FIG. 14A is a perspective view of a plurality of nested slats 1100 in accordance with example embodiments. In example embodiments, the plurality of nested slats 1100 may be comprised of a first slat 1100-1, a second slat 1100-2, a third slat 1100-3, a fourth slat 1100-4, a fifth slat 1100-5, a sixth slat 1100-6, a seventh slat 1100-7 and an eighth slat 1100-8 each of which resemble the aforementioned slat 1100. In example embodiments, the plurality of slats 1100 be supported by a jig as in the previous example. In example embodiments, an image forming device, for example, a router or a laser, may be used to form an image 1150 on the plurality of nested slats 100 as shown in FIG. 14B. Although example embodiments illustrate the image 1150 as being formed on the substantially flat and continuous surface 1130, this is not intended to be a limiting feature of the invention since the image 1150 may be formed on the discontinuous surface instead 1120.

In example embodiments, the plurality of slats 1100 may be used for several purposes. As in the earlier embodiment, the plurality of slats 1100 may be configured to attach to a window frame and thus may be used as a window covering. For example, the plurality of slats 1100 may be modified to be hung and adjusted with cords, etc., as are vertical and horizontal blinds. FIG. 15A shows the plurality of slats 1100 assembled as a horizontal blind. FIG. 15B shows the plurality of slats 1100 rotated and retracted to expose the window.

FIG. 16 is a view of another slat 2000 in accordance with example embodiments. In example embodiments the slat 2000 may resemble a prism. For example, as shown in FIG. 16, the slat 2000 may resemble an elongated member having a triangular cross section. In example embodiments, the cross section may form an equilateral triangle, though example embodiments are not limited thereto. For example, the cross-section of the slat 2000 may resemble another type of triangle such as an isosceles triangle or another type of triangle.

In example embodiments, because the slat 2000 has a triangular shaped cross-section, the slat 2000 may have a first major surface 1, a second major surface 2, a third major surface 3, a first end surface 4, and a second end surface 5. The three major surfaces 1, 2, 3 may resemble rectangular surfaces whereas the end surfaces 4 and 5 may resemble triangular surfaces. In example embodiments, a plurality of slats 2000 may be arranged adjacent to one another as shown in FIGS. 17, 18, and 19. As shown in FIGS. 17, 18, and 19, the slats 2000 may be arranged so that they form a substantially planer surface 2100. For example, as shown in FIGS. 17, 18, and 19, the substantially planer surface 2100 may be formed by aligning the first major surfaces 1 of each of the slats 2000.

As shown in FIG. 20, a plurality of the slats 2000 may be supported by a jig 2500 so that the first major surfaces 1 of the plurality of slats 2000 forms the substantially planer surface 2100. Because the plurality of slats 2000 is supported by a jig 2500, an image forming device, for example, a router or a laser, may be used to form an image 2110 on the substantially planer surface 2100. After the image is complete, the slats 2000 may be removed from the jig, rotated, and placed back into the jig 2500 so that another, unmarked, substantially planer surface, may be formed. For example, this latter unmarked substantially planer surface may be formed by aligning the second major surfaces 2 of the plurality of slats 2000. In example embodiments, the image forming device may be used again to form a second image 2120 on the plurality of slats 2000 as shown in FIG. 21. After the second image 2120 is formed, the slats 2000 may again be removed from the jig 2500 and rotated again so that the third major surfaces 3 of the slats 2000 are aligned to produce another substantially flat surface. In example embodiments, the image forming device may be used again to form a third image 2130 on the plurality of slats 2000 as shown in FIG. 20.

In example embodiments, the plurality of slats 2000 may be used in several applications. For example, the plurality of slats 2000 may be used as window covering. For example, as shown in FIG. 23, the plurality of slats 2000 with the images 2110, 2120, and 2130 formed thereon may be fitted with a plurality of posts that may insert into a plurality of holes 260′ and 270′ arranged in a frame 200′. FIGS. 25A-25C illustrate the plurality of slats 2000 fitted into the frame 200′. In example embodiments, the plurality of slats 2000 may be rotated so that their respective first major surfaces 1 are aligned to reveal the first image 2110 as shown in FIG. 25A. In example embodiments, the plurality of slats 2000 may be configured to rotated in the frame 200′, thus, each of the slats 2000 may be rotated such that their respective second major surfaces are aligned to reveal the second image 2120 as shown in FIG. 25B. Further yet, each of the slats may be rotated once again so that their respective third major surfaces 3 are aligned to reveal the third image 2130 as shown in FIG. 25C.

In example embodiments, each of the slats 2000 may be rotated individually or as a group. For example, as shown in FIG. 26, each of the posts on one side of the plurality of slats 2000 may be fitted with a sprocket 2700 and chain 2800 may be wrapped around the sprockets 2700 so that as the chain 2800 is moved up and down, the plurality of slats 2000 rotate as a group.

Thus far, example embodiments illustrate a product comprised of multiple slats, where the slats may be used as horizontal slats of a window covering. Example embodiments, however, are not limited thereto as the slats are not required to be horizontal. For example, the slats may be arranged vertically. Further more, the slats are not required to be arranged in a single plane and are clearly not limited to window coverings. For example, FIG. 27A illustrates a perspective view an example of a product 4000 comprised of multiple slats 5000 wherein the multiple slats 5000 are arranged in a circular pattern on a base 6000 to form in a three dimensional column. FIG. 27B illustrates a top view of the product 4000. In this particular nonlimiting example, the slats 5000 have circular cross-sections. Further, the slats 5000 are comprised of a transparent material. Further yet, a light emitting device 7000 may be located at the center of the circular pattern such that when the light emitting device emits light, the plurality of slats 5000 are illuminated. In example embodiments, the plurality of slats 5000 may have an outer surface marked, for example, by etching or engraving, to have an aesthetically pleasing image formed on the outside thereof. For example, in FIG. 27A, the multiple slats 5000 are etched so that when they are placed on the base 6000, a substantially continuous scenery about a circumference of the plurality of slats 5000 is revealed.

In example embodiments, color may be added to the slats to improve on image quality. For example, color may be added to an image using conventional inkjet technology to improve an image's appearance. Further, in the event the slats are made of a transparent material, light emitting devices, such as light emitting diodes, may be placed at ends of the slats to lighten the slats to further reveal images that may be formed thereon. In addition, various actuating devices, such as motors, may be incorporated into any of the designs in order to impart motion to the slats. For example, in FIG. 27A, each of the slats 5000 may be supported by a motor arranged between the slats 5000 and the base 6000 so that the slats 5000 may be rotated on their own respective axes.

While example embodiments have been particularly shown and described with reference to example embodiments thereof, it will be understood by those of ordinary skill in the art that various changes in form and details may be made therein without departing from the spirit and scope of the invention.

What we claim is:

1. A product comprised of:
a plurality of slats arranged in a structure, wherein the plurality of slats include a plurality of first surfaces that, when aligned, form a continuous image.

2. The product of claim 1, wherein the plurality of slats are comprised of a transparent material.

3. The product of claim 2, wherein the transparent material includes acrylic glass.

4. The product of claim 1, wherein the plurality of slats includes a second plurality of surfaces that, when aligned, form a second continuous image.

5. The product of claim 4, wherein the plurality of slats includes a third plurality of surfaces that, when aligned, from a third continuous image.

6. The product of claim 5, wherein the plurality of slats are comprised of a transparent material.

7. The product of claim 1, wherein the plurality of slats include a plurality of notches to allow the plurality of slats to nest against one another.

8. The product of claim 7, wherein a cross section of the plurality of slats is a half circle.

9. The product of claim 7, wherein each of the plurality of slats includes two parallel surfaces.

10. A window blind comprising:
the product of claim 1, wherein
the plurality of slats are nested,
the plurality of slats are assembled and act together,
the plurality of slats are comprised of transparent material,
the slat assembly has an image formed thereon by at least one of etching and engraving,
the assembled slats hang at least one of horizontally and vertically,
the slats are configured to at least one of rotate and be pulled together.

11. A door blind comprising:
the product of claim 1, wherein
the plurality of slats are nested,
the plurality of slats are assembled and act together,
the plurality of slats are comprised of transparent material,
the slat assembly has an image formed thereon by at least one of etching and engraving,
the assembled slats hang at least one of horizontally and vertically
the slats are configured to at least one of rotate and be pulled together.

12. A window shutter comprising:
the product of claim 1, wherein
the plurality of slats are nested,
the plurality of slats are assembled and act together,
the plurality of slats are comprised of transparent material,
the slat assembly has an image formed thereon by at least one of etching and engraving,
the assembled slats hang at least one of horizontally and vertically.

13. A door shutter comprising:
the product of claim 1, wherein
the plurality of slats are nested,
the plurality of slats are assembled and act together,
the plurality of slats are comprised of transparent material,
the slat assembly have an image formed thereon by at least one of engraving and etching, and
the assembled slats hang at least one of horizontally and vertically

14. The window covering of claim 10, wherein a cross section of the plurality of slats resembles a half circle.

15. The window covering of claim 10, wherein each of the slats of the plurality of slats include parallel surfaces.

16. The window covering of claim 10, wherein the slat are illuminated with lighting.

17. The window covering of claim 10, wherein the slats have motion imparted on them to enhance the aesthetic affect.

18. The window covering of claim 10, wherein each slat or the plurality of slats has color added to the image to enhance the aesthetic affect.

19. A method of forming a product comprising:
placing a plurality of transparent slats on a jig;
forming a first image on the plurality of transparent slats; and
attaching the plurality of transparent slats to a frame so that each of the plurality of transparent slats may rotate within the frame.

20. The method of claim 19, wherein forming the first image includes at least one of engraving and etching the plurality of transparent slats.

21. The method of claim 19, further comprising:
removing the plurality of slats from the jig;
rotating the plurality of slats and placing the plurality of slats back on the jig so that second surfaces of the plurality of slats are aligned; and
forming a second image on the second surfaces of the plurality of slats.

22. The method of claim 21, further comprising:
removing the plurality of slats from the jig;
rotating the plurality of slats and placing the plurality of slats back on the jig so that third surfaces of the plurality of slats are aligned; and
forming a third image on the third surfaces of the plurality of slats.
